(19) United States
(12) Patent Application Publication
(10) Pub. No.: US 2024/0028309 A1
(43) Pub. Date: Jan. 25, 2024

(54) SYSTEM AND METHOD FOR GENERATING PACKAGE FOR A LOW-CODE APPLICATION BUILDER

(71) Applicant: RAKUTEN SYMPHONY SINGAPORE PTE. LTD., Capitagreen (SG)

(72) Inventors: Florian LEMOINE, Montpellier (FR); Christopher PETIT, Montpellier (FR)

(73) Assignee: RAKUTEN SYMPHONY SINGAPORE PTE. LTD., Capitagreen (SG)

(21) Appl. No.: 17/871,032

(22) Filed: Jul. 22, 2022

(51) Int. Cl. G06F 8/34; G06F 9/52

(52) U.S. Cl. CPC G06F 8/34; G06F 9/52; G06F 2209/521

(57) ABSTRACT

A method includes receiving a request to generate an application. retrieving a low-code format, generating a low-code package based on the low-code format, and generating the application based on the low-code package. The low-code format is a cross-platform format supported by different application building platforms, and is constructed based on a human-readable universal support format.

### BACKGROUND

### 1. Field

Apparatuses and methods consistent with example embodiments of the present disclosure relate to generating a low-code package based on a low-code format.

### 2. Description of Related Art

In related art, a low-code application (App) building platform allows a user, who may not have experience or skill in coding, to build an App by, for example, pre-configured elements on a graphical user interface (GUI). However, conventional low-code App building platforms normally function as a black box, such that there is no availability of any readable/accessible information of the App descriptive file. Furthermore, the saved project may not be compatible with and unreadable by other platforms.

### SUMMARY

According to embodiments, systems and methods are provided for generating a low-code package based on a low-code format that is readable and compatible with multiple platforms.

According to an aspect of the disclosure, a method may include receiving a request to generate an application. retrieving a low-code format, generating a low-code package based on the low-code format, and generating the application based on the low-code package. The low-code format may be a cross-platform format supported by different application building platforms, and may be constructed based on a human-readable universal support format.

According to an aspect of the disclosure, a system may include a memory storing instructions, and a processor configured to execute the instructions to receive a request to generate an application. retrieve a low-code format, generate a low-code package based on the low-code format, and generate the application based on the low-code package. The low-code format may be a cross-platform format supported by different application building platforms, and may be constructed based on a human-readable universal support format.

According to an aspect of the disclosure, a non-transitory computer-readable storage medium may store instructions that, when executed, cause at least one processor to receive a request to generate an application. retrieve a low-code format, generate a low-code package based on the low-code format, and generate the application based on the low-code package. The low-code format may be a cross-platform format supported by different application building platforms, and may be constructed based on a human-readable universal support format.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of an example environment in which systems and/or methods, described herein, may be implemented;

FIG. 2 is a diagram of example components of a device according to an embodiment;

FIG. 3 is a diagram of an overall process for providing a low-code package, according to an embodiment;

FIG. 4 is a flowchart of a method for implementing a change associated to a low code format;

FIG. 5 is a flowchart of a method of generating an application based on a low-code format, according to an embodiment; and

FIG. 6 is a flowchart of a method of generating an application, according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

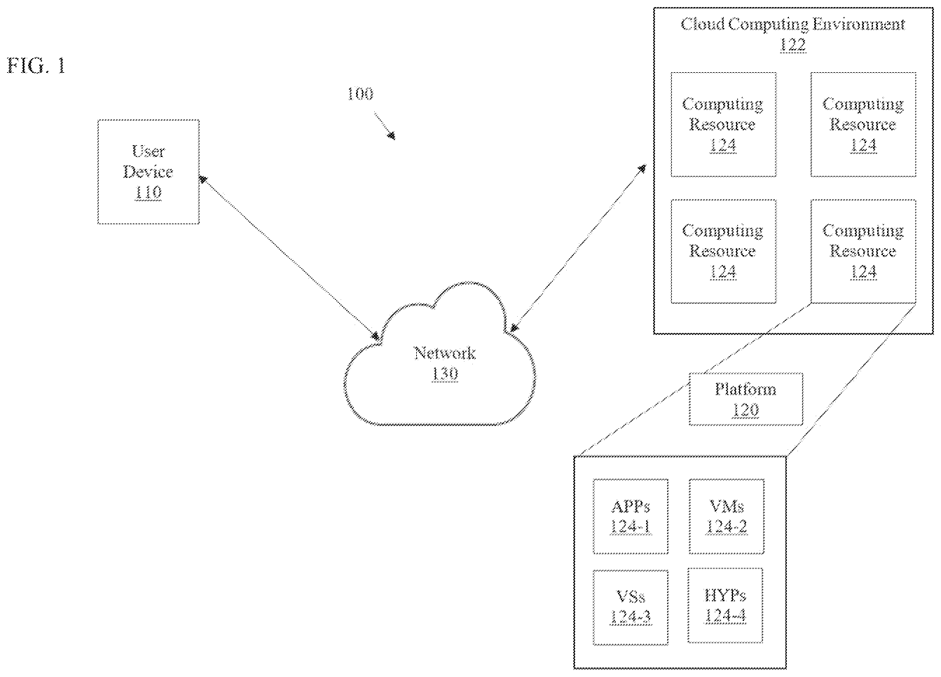

FIG. 1 is a diagram of an example environment 100 in which systems and/or methods, described herein, may be implemented. As shown in FIG. 1, environment 100 may include a user device 110, a platform 120, and a network 130. Devices of environment 100 may interconnect via wired connections, wireless connections, or a combination of wired and wireless connections. In embodiments, any of the functions and operations described with reference to FIG. 1 above may be performed by any combination of elements illustrated in FIG. 1.

User device 110 includes one or more devices capable of receiving, generating, storing, processing, and/or providing information associated with platform 120. For example, user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 110 may receive information from and/or transmit information to platform 120.

Platform 120 includes one or more devices capable of receiving, generating, storing, processing, and/or providing information. In some implementations, platform 120 may include a cloud server or a group of cloud servers. In some implementations, platform 120 may be designed to be modular such that certain software components may be swapped in or out depending on a particular need. As such, platform 120 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 may not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., user device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, a cluster of computing devices, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by user device 110. Application 124-1 may eliminate a need to install and execute the software applications on user device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., user device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

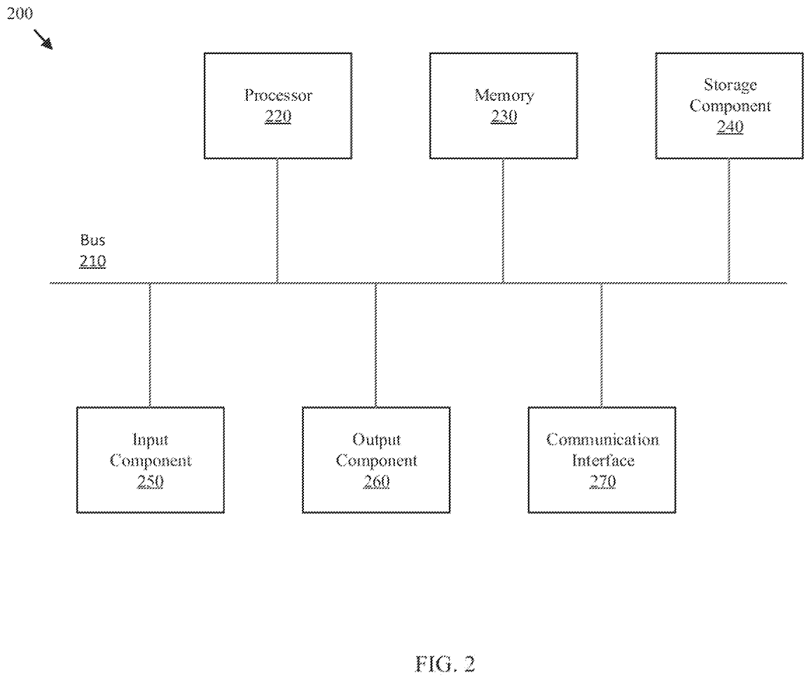

FIG. 2 is a diagram of example components of a device 200. Device 200 may correspond to user device 110 and/or platform 120. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

A low-code application building program may allow a user without programming experience or skills to build an application, such as by dragging-and-dropping pre-configured elements on a graphical user interface (GUI). Application building platforms may include two main modules: an application studio with which a user is interacting, and an application builder that builds an application based on the user's input. In particular, the application studio may include predefined elements (e.g., a button, a table, etc.) with which a user may interact, where each of the predefined elements has an associated code/artifact. The predefined elements may include different levels such as a first-level element indicating the basic building blocks (e.g., fonts, tags, color palettes, buttons, etc.) a second-level element indicating a combination of the first-level elements, a third-level element indicating a combination of the second-level elements, etc.

The predefined interactive elements may be provided by the application studio in different levels (e.g., from predefined icon to predefined templates), or the user may use the application studio to build their intended interactive elements from the lowest-level elements (e.g., combine a plurality of atom-level icons to form a molecule-level element, etc.). These multi-level elements concept provide flexibility for a user to customize their application.

After the user has completed the design of the intended application on the application studio, the application studio may collect the information of each interactive element and build an application descriptive file representing the intended application (e.g., intended design, function, etc.). The application studio may then provide the application descriptive file to the application builder. The application builder may then generate an application based on the provided application descriptive file.

Conventional low-code application building platforms normally function as a black box, in that the application studio will directly provide the application descriptive file to the application builder for generating the application. The conventional application descriptive file is encoded, platform-dependent, and not human readable. Thus, there is no availability of any readable/accessible information of the application description file. Such a situation is not convenient for a user that has knowledge and experience in application development, because the information contained in the application descriptive file may be useful and/or required by the user. For example, without the insight or information of the application descriptive file, it will be difficult for performing debugging, enhancement, planning, application version updating. Specifically, in conventional low-code application building platforms, when the user is not satisfied with the application built by the platform, the user may need to either return to the application studio and rebuild the design with the predefined elements or simply build a new application. Thus, users with application development knowledge and experience will typically refrain from using a low-code application building platform.

Furthermore, saved projects in conventional low-code application building programs are not compatible with and not readably by other platforms. When a user is working on designing an application on the application studio, the user can save a copy of their project (in the form of application descriptive file supported by the application studio/application building platform) in the application studio. Later, in order to access the saved copy, the user is required to use the application studio to locate the saved copy (e.g., from a local drive or cloud drive). The application studio will retrieve the saved copy, decode the saved copy to identify the elements involved in the application descriptive file, collect the identified elements to build the application descriptive file, and then present the application descriptive file to the user. Although the user may have access to the saved copy, the application descriptive file is normally encoded and is not in readable format. Only the particular application studio/application building platform can decode and read the saved copy. Thus, in the situation where the application building platform breaks down or the service is terminated (i.e., the application building platform is no longer usable by the user), the saved copy representing the user's application design/configuration will be useless, because other platforms cannot read and understand the saved copy.

In view of the above, conventional application building platforms do not provide a good backup scheme for a built application, do not provide cross-platform collaboration in building an application, provide difficulty in debugging/versioning/enhancement, and not friendly to users with application building programming experience and skill.

Thus, provided herein is a system and method which build a low-code project package, where the information of the design chosen in the application studio is clearly sorted based on the respective level (e.g., different levels in an atomic design) and category (design information, setting information, service information, business logic information, etc.). The low-code package may be constructed in a universal support format (e.g., JavaScript Object Notation (JSON) format), which is supported by a large number of low-code/no-code application building platforms.

The systems and methods may provide a viewing module for optionally presenting the low-code package to users before sending the low-code package to an application builder. The users may also export the low-code package via the viewing module.

The systems and methods provide readable and useful information for an expert user, while maintaining the simplicity in operation required for a non-expert user. The systems and methods present artifact information according to levels and categories, which may improve the readability and efficiency in debugging, versioning, etc. The systems and methods provide cross-platform collaboration (i.e., a user using a first platform may export the artifact profile and provide it to another user using a second platform). The systems and methods also provide enhanced artifact backup.

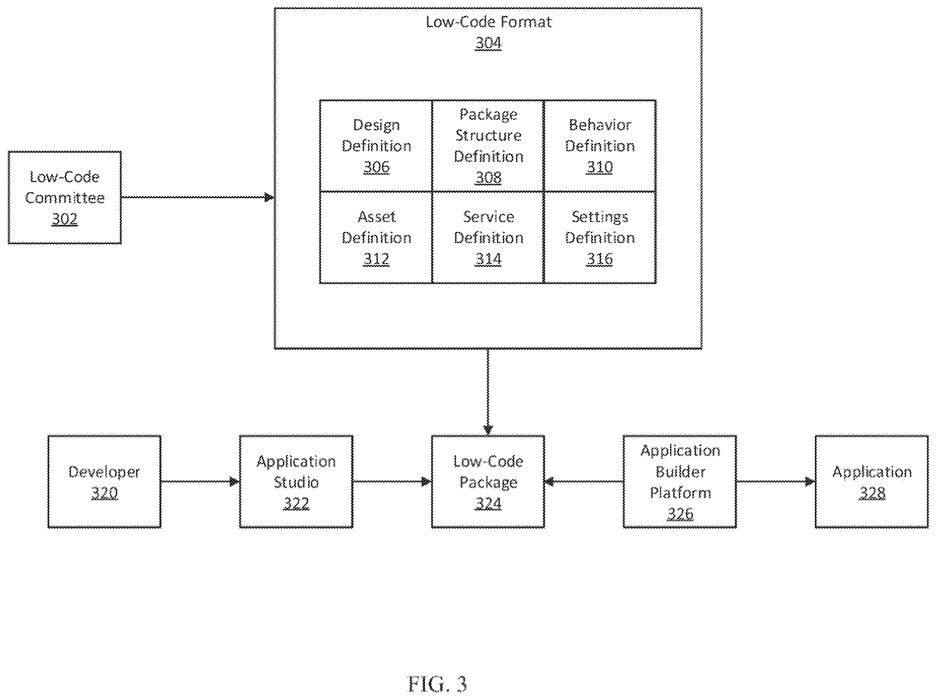

FIG. 3 is a diagram of an overall process for providing a low-code package, according to an embodiment. A low-code committee 302 may define a low-code format 304, which may include a design definition 306, a package structure definition 308, a behavior definition 310, an asset definition 312, a service definition 314 and a settings definition 316. The design definition 306 may include information related to the design of the application, such as a color of a button, font size, page content presentation, etc. The package structure definition 308 may include general information, such as an application name, descriptions of the application, etc. The behavior definition 310 may include information for a developer, such as the business logic of the application, workflow, operational algorithms, etc. The asset definition 312 may include information for a developer or designer, including images of the application, a translation of the application, etc. The service definition 314 may include service information, such as a definition of all external services (e.g., social media, payment platform, ticket creation, feature extension/plug-in, etc.), application programming interface (API) information, etc. The settings definition 316 may include configuration information of the application, such as time-zone, default languages, etc.

A developer 320 may utilize an application studio 322 to generate a low-code package 324. The system may provide the low-code format 304 to the application studio 322, and the application studio 322 may generate the low-code package 324 based on the low-code format 304. An application builder platform 326 may utilize the generated low-code package 324 to produce an application 328.

The low-code format 304 may be defined by the low-code committee 302, which may be a group of platform managers (e.g., manager(s) of the application studio 322, manager(s) of the application builder platform 326, and/or any other suitable personnel), and the low-code format 304 may be saved in a low-code format file. The low-code format file may specify how the application studio 322 should create a project package (e.g., how to store the information, etc.). The application studio 322 may retrieve the low-code format file from, for example, a server device, and then generate, based on the low-code format file, a low-code package 324 based on the low-code format file. The low-code package 324 may then be stored in a storage device. The application builder platform 326 may retrieve the low-code package 324 from the storage device and build an application based on the low-code package 324. A user may access a viewing module, and the viewing module may retrieve the low-code package 324 from the storage device and present, via a display device the information of the low-code package 324 in the low-code format 304.

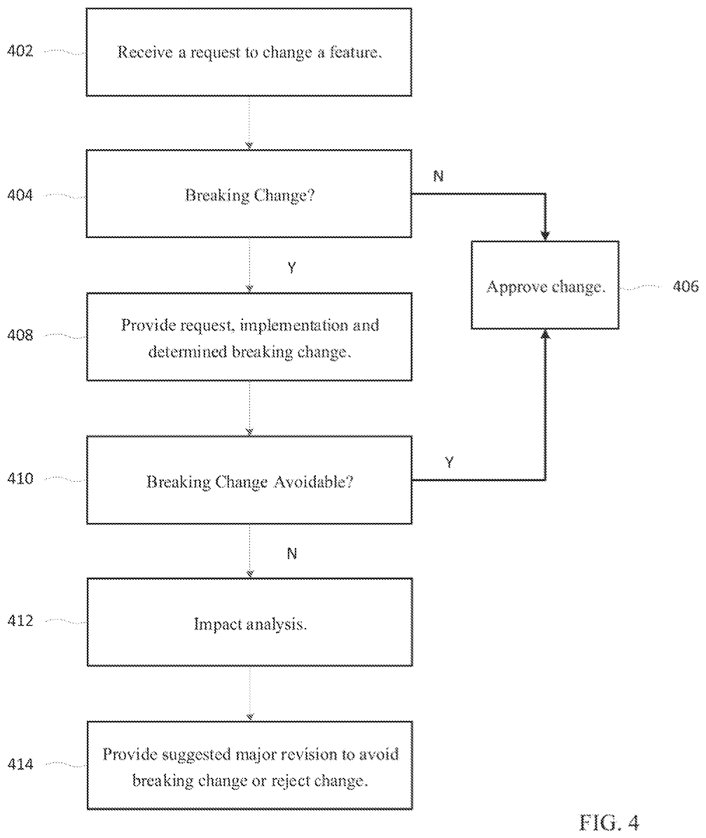

FIG. 4 is a flowchart of a method for implementing a change associated to a low code format (e.g., a feature change which may lead to a change in the low code format), according to an embodiment. In operation 402, the system may receive a request to change a feature of the application studio and/or application builder platform. The request may be received from a user of the application studio and/or application building platform, for example, an app developer, etc. The change request may be provided to a first terminal of a first user (e.g., a member of a development team) for review and approval. In operation 404, the first user may determine (e.g., via the first terminal) how the requested change should be implemented and whether or not implementing the requested change will cause breaking change (e.g., a change that brings negative impact to the system such as causing system failure, causing other users unable to properly view a feature in the system, etc.). If it is determined that the requested change is not a breaking change, then in operation 406, the first user may approve (via the first terminal) the change request and implement (via the first terminal) the requested change (with or without revision on the requested change). If it is determined that the requested change is a breaking change, then in operation 408, the first user may provide (via the first terminal) the change request, the proposed implementation method, and the determined breaking change, to a second terminal of a second user (e.g., a member of low-code committee, etc.) for further review. In operation 410, the second user may further review (via the second terminal) the change request, the proposed implementation method, and the determined breaking change, and then determine (via the second terminal) whether or not there is a way to avoid the breaking change (e.g., using another implementation method, suggest modification in the requested change, etc.). If it is determined that the breaking change is avoidable, then in operation 406, the second user may approve (via the second terminal) the change request and implement (via the second terminal) the change request (with minor revision/modification in the implementation method and/or the requested change). If it is determined that the breaking change is not avoidable, then in operation 412, the second user may perform (via the second terminal) an impact analysis on the breaking change (e.g., how many users will be affected by the breaking change, how long the breaking change will last, etc.). Accordingly, in operation 414, the second user may provide (via the second terminal) to the change requestor a suggestion on major revision on the requested change (e.g., major revision that can avoid breaking change, reduce the impact of the breaking change, etc.), so that the change requestor may modify the change request and re-submit the modified change request for approval. In some embodiments, the second user simply reject the change request if the impact of the breaking change is above an acceptable condition.

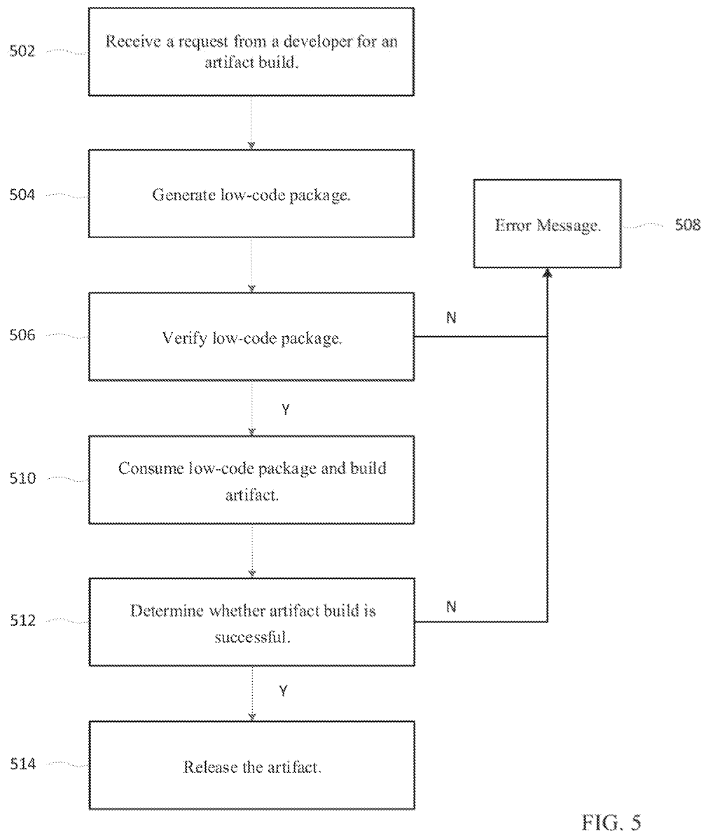

FIG. 5 is a flowchart of a method of generating an application based on a low-code format, according to an embodiment. In operation 502, an application studio may receive a request from a user (e.g., a developer) for an artifact build. In operation 504, the application studio may generate a low-code package. The application studio may generate the low-code package based on a low-code format. In operation 506, an application builder may verify the low-code package. If the application builder is unable to verify the low-code package, in operation 508, the application builder returns an error message. If the application builder is able to verify the low-code package, in operation 510, the application builder may consume the low-code package and build the artifact. In operation 512, the application builder may determine whether the artifact build is successful. If the artifact build is not successful, the application builder may return an error message as in operation 508. If the artifact build is successful, then in operation 514, the application builder may release the artifact.

As set forth above, the application studio generates a low-code package based on a low-code format in accordance with example embodiments. The low-code format in accordance with example embodiments is a cross-platform format that is universally supported by a plurality of different application builders. As a result, the application may be generated by an application building platform from an application descriptive file (i.e., low-code package) built by another application building platform. Unlike the conventional low-code application builders, developers are not handcuffed to one platform in the process of developing or updating a low-code application. Example embodiments allow a developer using a first platform to export the application package (i.e., application descriptive file or artifact information/profile) and provide it to a user using a second platform different from the first.

Further, the low-code format in accordance with example embodiments presents artifact information (i.e., the code corresponding to the predefined elements selected by the developer (e.g., citizen developer) in building the application) according to level and category (i.e., different user groups and user usages). As discussed above, the predefined elements may include different levels such as a first-level element indicating the basic building blocks (e.g., fonts, tags, color palettes, buttons, etc.) a second-level element indicating a combination of the first-level elements, a third-level element indicating a combination of the second-level elements, etc., and may be selectable via the application studio by a developer by drag and drop (or any other method) to design the application. Additionally, the low-code format in accordance with example embodiments is based on a human-readable programming format or language, such as an object-oriented format that uses human-readable text to define objects consisting of easy to read pairs of attributes and values. Because the low-code format presents the corresponding artifacts in human-readable text and according to their level and category, the readability of the package is easier than conventional application descriptive files, and debugging, versioning, etc., is more efficient.

The low-code format may be implemented in an atomic design. The atomic design may include base-level components, first-level atoms constructed based on the base-level components, second-level molecules constructed based on the atoms, third-level organisms constructed based on the molecules, fourth-level templates constructed based on the organisms, and fifth-level pages constructed based on the templates.

In some embodiments, the information in the low-code packages are categorized into information suitable/useful/informative to different user groups. As shown in FIG. 3, the information may be categorized into design information/definitions which include information that is useful for a designer, such as a user-interface design team, into behavior information/definitions which include information that is useful for the developer/programmer, etc. The categorized information is further categorized into different atomic level designs as shown in the Tables below. Furthermore, the low-code package is not encoded, meaning that the low-code package can be readily accesses and easily read across multiple developers and multiple platforms.

Table 1 provides an example structure for design definition 306 of a low-code package. The design definition 306 may be based on or written in a human-readable and cross-platform programming or file format, such as the JSON universal support format.

TABLE 1

| Level | Description | Examples |
|---|---|---|
| Atom | Define an | Atoms includes: |
| | Atom(s) item | a button, a text field, an icon, a label |
| Molecule | Define an | Molecules include: |
| | Molecule(s) | a button with a text field, an icon with |
| | item | a label |
| Organism | Define an | Organisms include: |
| | Organism(s) | a list comprising two buttons, wherein |
| | item | each of the buttons includes a text field |
| | | a header comprising two icons, wherein |
| | | each of the icons includes a label |
| Template | Define an | Templates include: |
| | Template(s) | a template of product list, wherein the |
| | | template comprises a list and a header |

It can be understood that Table 1 is merely an example, and the actual embodiments are not limited thereto. Further, it can also be understood that other information of the low-code package (e.g., package structure definition 308, behavior definition 310, asset definition 312, service definition 314, and settings definition 316) can also be presented in atomic design levels in a similar manner.

Table 2 is an example of a structure of a low-code package (e.g., the low-code package 324 of FIG. 3) that is generated based on the low-code format, such as the JSON based low-code format of Table 1.

TABLE 2

| namespace | Description | Examples |
|---|---|---|
| / | Root of the Low- | |
| | Code Package | |
| /atoms/ | Namespace where | |
| | are defined the | |
| | Atoms | |
| /atoms/<atom name>/ | Namespace of an | /atoms/primary-button/ |
| | Atom | /atoms/paragraph-textfield/ |
| /atoms/<atom | Namespace of the | /atoms/primary-button/assets/image.png |
| name>/assets/ | Assets of an Atom | /atoms/paragraph-textfield/assets/image.png |
| /atoms/<atom | The Atom definition | /atoms/primary-button/ primary-button.json |
| name>/<atom | | /atoms/paragraph-textfield/paragraph-textfield.json |
| name>.json | | |
| /molecules/ | Namespace where | |
| | are defined the | |
| | Molecules | |
| /molecules/<molecules | Namespace of a | /molecules/search-form/ |
| name>/ | Molecule | /molecules/product-card/ |
| /molecules/<molecules | The Molecule | /molecules/search-form/search-form.json |
| name>/<molecules | definition | /molecules/product-card/product-card.json |
| name>.json | | |
| /organisms/ | Namespace where | |
| | are defined the | |
| | Organisms | |
| /organisms/<organism | Namespace of a | /organisms/store-header/ |
| name>/ | Organism | /organisms/footer/ |
| /organisms/<organism | The Organism | /organism/store-header/search.json |
| name>/<organism | definition | /organism/footer/ footer.json |
| name>.json | | |
| /templates/ | Namespace where | |
| | are defined the | |
| | Templates | |
| /templates/<templates | Namespace of a | /templates/profile-page/ |
| name>/ | Templates | /templates/store-store/ |
| /templates/<templates | The Templates | /molecules/profile-page/profile-page.json |
| name>/<templates | definition | /molecules/store-store/store-store.json |
| name>.json | | |
| /i18n/ | Namespace for i18n | |
| | data | |
| /i18n/<locale>/ | Namespace of a | /i18n/fr_FR/ |
| | Locale | /i18n/en_US/ |
| /i18n/<locale>/locals.i18n | a Key/Value file | /i18n/fr_FR/locals.i18n |
| | | /i18n/en_US/locals.i18n |
| /i18n/<locale>/settings.json | Locale Application | /i18n/fr_FR/settings.json |
| | Settings | /i18n/en_US/settings.json |
| /i18n/<locale>/assets/ | Namespace of a | /i18n/fr_FR/assets/ |
| | Locale Assets | /i18n/en_US/assets/ |
| /i18n/<locale>/assets/<image | A Locale Assets | /i18n/fr_FR/assets/banner.png |
| name>.(png, jpeg . . .) | | /i18n/en_US/assets/banner.png |

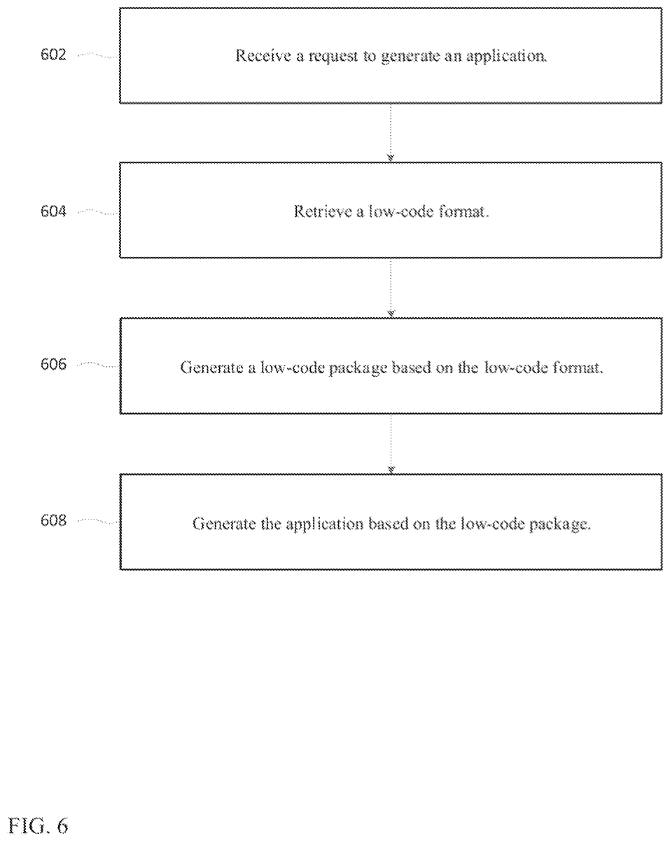

FIG. 6 is a flowchart of a method of generating an application, according to an embodiment. In operation 602, the system may receive a request to generate an application. In operation 604, the system may retrieve a low-code format. In operation 606, the system may generate a low-code package based on the low-code format. In operation 608, the system may generate the application based on the low-code package. The low-code format may be constructed based on a universal support format.

In embodiments, any one of the operations or processes of FIGS. 3-6 may be implemented by or using any one of the elements illustrated in FIGS. 1 and 2.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method, comprising:
receiving a request to generate an application;
retrieving a low-code format;
generating a low-code package based on the low-code format; and
generating the application based on the low-code package,
wherein the low-code format is a cross-platform format supported by different application building platforms, and is constructed based on a human-readable universal support format.

2. The method of claim 1, wherein the universal support format comprises JavaScript Object Notation (JSON) format.

3. The method of claim 1, wherein the low-code format comprises an atomic design.

4. The method of claim 3, wherein the atomic design comprises base-level components, first-level atoms constructed based on the base-level components, second-level molecules constructed based on the atoms, third-level organisms constructed based on the molecules, fourth-level templates constructed based on the organisms, and fifth-level pages constructed based on the templates.

5. The method of claim 2, wherein the low-code format comprises a features section defining at least one of a color schema, a text schema, a number schema, and a font schema.

6. The method of claim 1, further comprising verifying the low-code package.

7. The method of claim 6, further comprising generating an error message based on being unable to verify the low-code package.

8. A system, comprising:
a memory storing instructions; and
a processor configured to execute the instructions to:
receive a request to generate an application;
retrieve a low-code format;
generate a low-code package based on the low-code format; and
generate the application based on the low-code package,
wherein the low-code format is a cross-platform format supported by different application building platforms, and is constructed based on a human-readable universal support format.

9. The system of claim 8, wherein the universal support format comprises JavaScript Object Notation (JSON) format.

10. The system of claim 9, wherein the low-code format comprises an atomic design.

11. The system of claim 10, wherein the atomic design comprises base-level components, first-level atoms constructed based on the base-level components, second-level molecules constructed based on the atoms, third-level organisms constructed based on the molecules, fourth-level templates constructed based on the organisms, and fifth-level pages constructed based on the templates.

12. The system of claim 9, wherein the low-code format comprises a features section defining at least one of a color schema, a text schema, a number schema, and a font schema.

13. The system of claim 8, wherein the processor is further configured to execute the instructions to verify the low-code package.

14. The system of claim 13, wherein the processor is further configured to execute the instructions to generate an error message based on being unable to verify the low-code package.

15. A non-transitory, computer-readable storage medium storing instructions that, when executed, cause at least one processor to:
receive a request to generate an application;
retrieve a low-code format;
generate a low-code package based on the low-code format; and
generate the application based on the low-code package,
wherein the low-code format is a cross-platform format supported by different application building platforms, and is constructed based on a human-readable universal support format.

16. The storage medium of claim 15, wherein the universal support format comprises JavaScript Object Notation (JSON) format.

17. The storage medium of claim 16, wherein the low-code format comprises an atomic design.

18. The storage medium of claim 17, wherein the atomic design comprises base-level components, first-level atoms constructed based on the base-level components, second-level molecules constructed based on the atoms, third-level organisms constructed based on the molecules, fourth-level templates constructed based on the organisms, and fifth-level pages constructed based on the templates.

19. The storage medium of claim 16, wherein the low-code format comprises a features section defining at least one of a color schema, a text schema, a number schema, and a font schema.

20. The storage medium of claim 15, wherein the instructions, when executed, further cause the at least one processor to verify the low-code package.
